(19) United States
(12) Patent Application Publication
(10) Pub. No.: US 2014/0197623 A1
(43) Pub. Date: Jul. 17, 2014

(54) Rust Repair Kit for Ford Mustang 1979-1993 Front Frame Rails

(71) Applicant: Bradley Wayne Dralle, Coatsburg, IL (US)

(72) Inventor: Bradley Wayne Dralle, Coatsburg, IL (US)

(21) Appl. No.: 13/743,549

(22) Filed: Jan. 17, 2013

(51) Int. Cl. B62D 21/18

(52) U.S. Cl. CPC B62D 21/18
USPC 280/781

(57) ABSTRACT

A Rust Repair Frame Rail Kit for left or right side for the model year 79-93 Ford Mustang. They are position from the firewall to the front radiator support. They are cut out of 12 and 14 gauge metal with a PlasmaCam System then bent to form the part. The frame rail includes; front frame rail channel, inter bumper support, inter tow hook support, sway bar mount and saddle, top cap over front top of frame rail, crush tube and plate, inter strut tower plate and the rear saddle. All pieces are placed in the frame rail in the proper position and welded in to make a complete replacement of damaged frame rails. Holes are in the proper position for mounting the existing components back into the original location for reassembling.

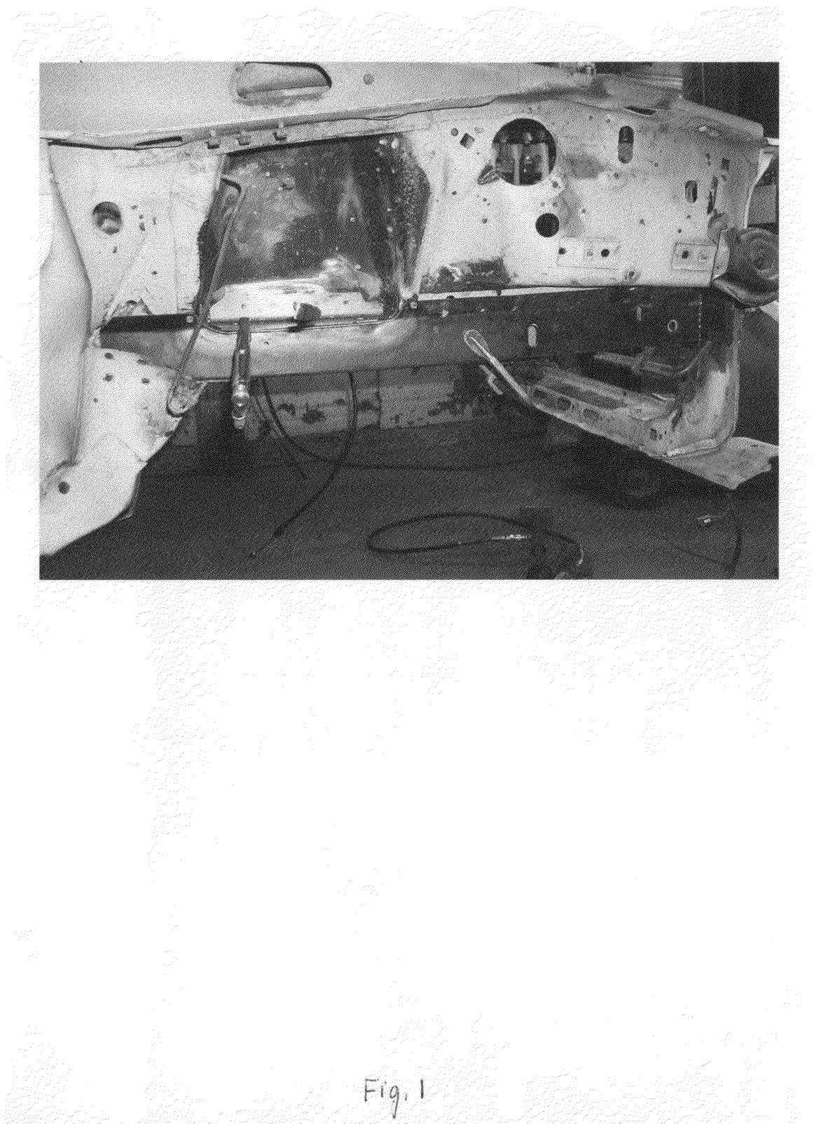

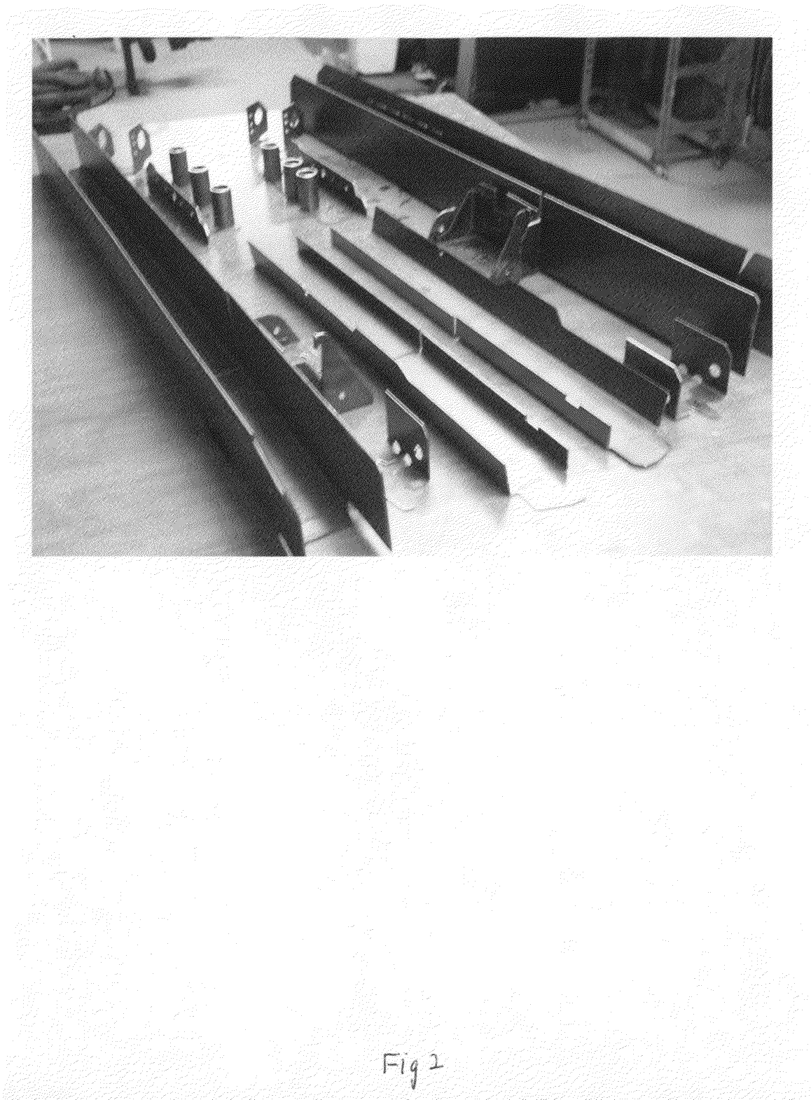

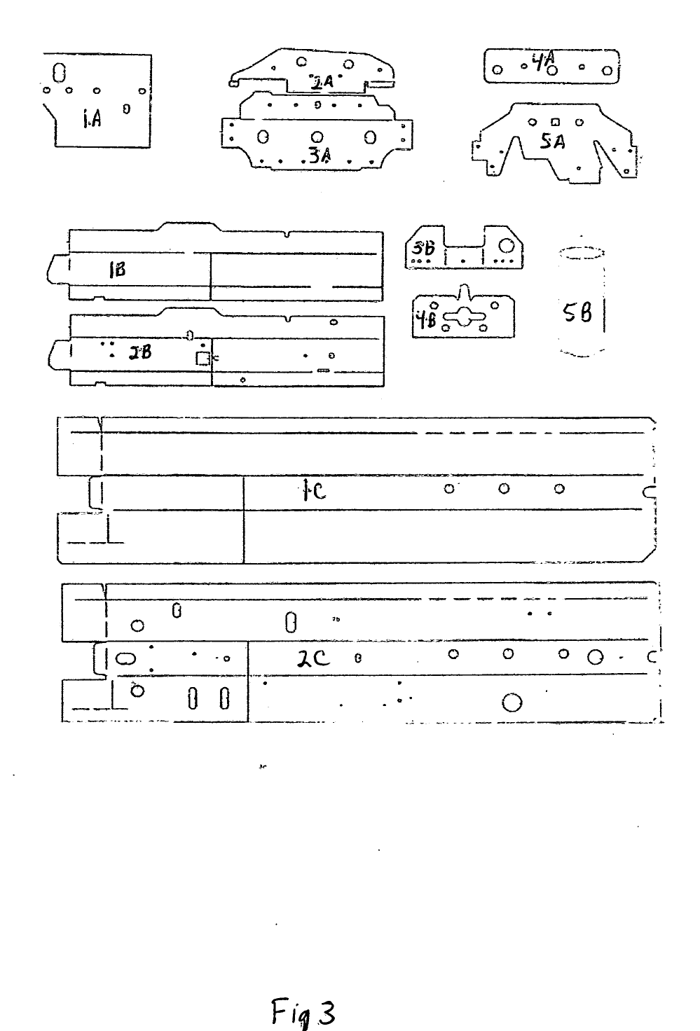

FIG. 3 This is the AutoCAD Drawing that is used when they are cut out by the plasma cam.

A complete description of each part, refer to FIG. 3 and corresponding pictures.

1A. This is the inter Tow Hook Support, the part is made from 12 gauge metal and will go into the frame rail to where the oblong tow hook hole is in the frame. Once the Inter Tow Hook Support is welded in it will add to the strength where the tow hook is attached. Also see picture A4.

2A. Sway bar Mount Saddle is made from 14 gauge and will go under the sway bar mount for added support in that area. Also see picture A3.

3A. Inter Strut Tower Plate. This piece is cut from 14 gauge metal and covers the frame rail inside the strut tower and is used to be the top mounting point for the K-member bolts to go thru. Once welded in it will add support for the frame rail and also the mounting bolts of the K-member. Also see picture A7.

4A. Lower Crush Tube Plate. This piece is made from 12 gauge metal and is used to weld the crush tubes onto for the K-member bolts to pass thru. This keeps the bolts from crushing the frame rail. See picture A5.

5A. Sway Bar Mount is made from 12 gauge metal and is welded on the side of the frame rail to mount the sway bar into place. Also see picture A3.

1B. Top Cap with no holes. This piece sets on top of the frame rail between the strut tower and the radiator support. It adds strength to the rail by boxing it in once it is welded. See picture A2B.

2B. Top Cap with holes. The top caps are made from 14 gauge metal and is used to box in the frame rail between the strut tower and the radiator support. We made them with and without the holes per customer comments desiring a smooth type rail without all the extra holes in them. Picture A2.

3B. Rear Outer Saddle. The piece is made from 14 gauge metal and is used as saddle for the rear of the frame rail next to the firewall. See also picture A8.

4B. Bumper Bolt Support. Made from 12 gauge metal and is used as extra support for the bumper mount bolt to go thru the frame rail and the support. The piece is welded in. See also picture Al.

5B. Crush Tubes are 1″ OD and ⅛″ wall pipe cut to be welded onto 4A. And are used inside the frame rail where the K-Member bolts go thru. They are used to keep the bolts from crushing the frame rail when the bolts are tightened down. Also picture A6.

1C. Smooth Frame Rail. The frame rails are cut from 14 gauge metal with the holes for the K-Member bolts to go thru. Per customers request, we deleted the extra hole that where put into the OE Style Rails. They prefer to have the smooth rails for high end show cars that keep the engine compartment clean and smooth appearance. Picture A10.

2C. OE Style Frame Rail, Made from 14 gauge metal, this frame rail will have the extra holes in it to have the same look as the original one has. This frame rail is for the Mustang that is being restored back to stock appearance. Once installed properly it will as the original frame rail would look. See Also picture A9.

1. The Rust Repair Kits are designed to replace the rusted frame rails that are a problem with the era of Mustangs. So many of the cars are destroyed because of the rust and not having the replacements available until now. I have received comments that I have saved an era of Mustangs and have saved several from being crushed by designing and manufacturing the rails. To the best of my knowledge no one has made a replacement or can get them thru Ford.
I feel that I have a good design and have used material that is comparable to the OE style. We mad them as kits so an individual can measure and fit as close to original as possible.
I'm an individual inventor that would like to be protected from other designers that could copy the idea. We would like to increase manufacturing and to succeed.
